(19) United States
(12) Patent Application Publication
(10) Pub. No.: US 2002/0178252 A1
(43) Pub. Date: Nov. 28, 2002

(54) Extensible service provisioning engine

(75) Inventors: Srinivas Balabhadrapatruni, Westford, MA (US); Prasad Dorbala, Lexington, MA (US); Satish L. Yellanki, Lowell, MA (US); Sunil K. Kotagiri, Lowell, MA (US); Srinivas Loke, Westford, MA (US); Charles Bear, Arlington, MA (US); Ravi S. Kumar, Shrewsbury, MA (US); Vikram Saksena, Acton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Narad Networks, Inc., Westford, MA (US)

(21) Appl. No.: 10/143,728

(22) Filed: May 8, 2002

Related U.S. Application Data
(60) Provisional application No. 60/289,617, filed on May 8, 2001.

(51) Int. Cl. G06F 15/16; G06F 15/173

(52) U.S. Cl. 709/223

(57) ABSTRACT

In a network system, services are provided to users via network interconnections from a service provider. Such services include data, voice, video, and others, and are typically implemented and/or initiated via an interconnection from a network node operated by the service provider to customer premises equipment (CPE) operable to receive the service. Service provisioning includes identifying the service to be provided, identifying the CPE to receive the service, and the determining the manner in which the service is to be provided. In an execution environment such as a hybrid fiber-coax (HFC) network, service deployment time and cost, and maintenance are reduced, and reliability increased, by an executable element generator operable to generate workflow definition files, such as an XML (Extensible Markup Language) script. A plurality of services are defined according to a workflow model, in which each of the services corresponds to one or more of the executable scripts. A service provisioning engine such as a workflow manager is operable to execute the executable scripts for providing the corresponding service via the network. The service provisioning engine reads the executable scripts from a common repository such as an LDAP directory, and provides or initiates the service by communicating, via the network, with the CPE.

### RELATED APPLICATIONS

This application claims the benefit of U.S. Provisional Application No. 60/289,617, filed on May 8, 2001, Attorney's Docket No. 3070.1004-000. The entire teachings of the above application are incorporated herein by reference.

### BACKGROUND OF THE INVENTION

In a network system, services are provided to users via network interconnections from a service provider. Such services include data, voice, video, and others, and are typically implemented and/or initiated via an interconnection from a network node operated by the service provider to customer premises equipment (CPE) operable to receive the service. Customer premises equipment may include, for example, PCs, TVs, wired and wireless phones, mass storage devices, or other service, or network elements operable to be interconnected over the network. Service provisioning in this manner includes identifying the service to be provided, identifying the CPE, or network node, to receive the service, and determining the manner in which the service is to be delivered to the end-user. A provisioned service is then available to be provided and utilized by a user on demand by a simple discrete operation such as a mouse click or infrared remote selection.

One method of providing services to an end user includes so-called hybrid fiber coax (HFC) networks. Physically extending the network into the home of each user would be cumbersome, however many homes are already interconnected by coaxial cables employed for carrying legacy cable television signals. Such HFC networks employ a high speed networking device, such as an optical networking unit (ONU), at a point which is capable of accessing 500-1000 end user homes via the existing coax cable plant. Tapping into the tree-and-branch topology of the legacy coax network allows high speed ONUs to be installed only once for every 500-1000 homes, rather than in every home. This approach allows the high-speed optical network to be employed for much of the physical distance, and employs the existing legacy coax for the so-called “last mile” run to individual users. By employing frequencies on the coax typically above the frequency already employed for cable TV, HFC networks utilize unused bandwidth to overcome the “last mile” problem and provide services to users efficiently and economically.

Service provisioning, therefore, typically involves identifying a number of network nodes and instructions, for example machine instructions for configuring a particular hardware element, concerned with providing a particular service, and directing the nodes by transmitting appropriate instructions to which the nodes are responsive. In order for the service to be properly provisioned, concerned nodes must be accurately identified and the proper instructions transmitted accordingly. Often, however, there are many different types of nodes on such a network, each responsive to a different set of instructions. Further, each service typically requires a specific corresponding set of instructions to be transmitted. Still further, new services and new nodes are frequently added or upgraded, requiring additional instructions or modification of existing instructions, in order to provision the service.

In a typical prior art service provisioning system, multiple sets of instructions are maintained for each of the various services, and for each of the hardware element types which may be invoked in providing the service. Each provision of the service requires identifying a set of the concerned instructions, often called an adaptor, and performing an aggregation, such as a compilation or interpretation, of the set of instructions concerned with the particular instantiation, thereby resulting in a specific build of the service. Frequently, multiple builds are maintained to correspond to different customer sites and different services which are to be provided to that site. However, maintaining multiple builds and multiple adaptors raises maintenance and development issues. Such adaptors are often written in a low level language specific to a particular platform. In a non-monolithic system, i.e. a system having many platforms, a different adaptor may be required for each supported platform. The need for multiple adaptors can result in increased deployment time and increased cost as custom adaptors and builds are deployed to adapt to new or upgraded services and hardware to be provisioned.

Therefore, service provisioning has typically been performed by manually configuring the provisioning objects concerned with providing the desired service. Further manual steps are required to update databases such as service availability, accounting, and usage repositories which define a particular service plan. System upgrades such as new provisioning objects and revisions to service plans must also be manually retrofitted across the network to update existing provisioned services. Such manual deployment of services increases the time required to deploy the service, increases cost because of multiple manual operations which must be applied, and can tend to be error prone from a need to ensure that all manual operations are complete.

### SUMMARY OF THE INVENTION

In a network services delivery environment, service deployment time, cost and maintenance are reduced, and reliability increased, by a system for provisioning services over a network which includes an executable element generator operable to generate executable scripts recognized across an execution environment. A plurality of services are defined, in which each of the services corresponds to one or more of the executable scripts. The services are provided via a network in communication with, and operable to provide the services to, each of a plurality of users. A service provisioning engine (SPE) is operable to execute the executable scripts for providing the corresponding service via the network. The SPE reads the scripts and associated parameters from a common repository such as a knowledge base, and provides or initiates the service by transmitting information signals, via the network, to one or more customer premises equipment units, such as PCs, televisions, and telephones at the customers site.

A workflow manager may be employed by the SPE for provisioning services in an automated, modular manner. A workflow is defined to correspond to a particular service provisioning request. The workflow is defined in executable scripts called workflow definition files. Each workflow includes a series of tasks executed according to the sequence, conditions, and states specified by the workflow. The workflow definition files incorporate such tasks via additional executable scripts which define each task and are stored as task definition files. The workflow manager may therefore process and apply the workflow in a modular manner by executing the workflow definition files. The modular structure of the workflow definition files allows for extensions, modifications, and upgrades through the individual workflow and task definition files.

The network as employed herein therefore defines an execution environment upon which the executable scripts are executed. Provisioning objects such as hardware devices are deployed and interconnected by the network. The provisioning objects are configured by configuration parameters for the particular provisioning object. The configuration parameters coordinate the provisioning object for a particular service, such as assigning ports and buffers within a device. Services such as voice, video, and data are defined and employ the provisioning objects through manipulation of element parameters of the provisioning objects concerned with providing the service, for example, bit rate or QOS (Quality of Service). Each of the services, further, is implemented by instantiations of service plans, each service plan enumerating service parameters for identifying variables and aspects associated with the particular instantiation of the service, such as price and duration.

The executable element generator employed in the service provisioning system is operable to produce executable scripts, such as an XML conformant file, for a particular network entity, such as provisioning objects, services, and service plans. In a particular embodiment there are three types of executable scripts generated by the executable element generator, also called a module builder. These executable scripts are employed, or consumed, by three types of script processors. A network pre-provisioning generator (NPP) is operable to define the configuration parameters corresponding to each of the provisioning objects. A service plan, or creation, manager (SPM) is operable to define the element parameters corresponding to each of the services with respect to a provisioning object. A service provisioning manager (SM) is operable to define service plans for deploying an instance of the service. Each of the script processors is preferably a graphical user interface (GUI) directed to seamlessly guiding an operator through processing an executable script to define the desired provisioning parameters (parameters) in the executable script for the concerned provisioning object.

The system further includes a knowledge base, which may be for example an LDAP (Lightweight Directory Access Protocol) directory, for storing the executable scripts and related parameters. The service provisioning engine accesses the knowledge base via an indicator, and provisions the service by reading the provisioning parameters defined from executable scripts by the script processors, and deploying the service at the particular CPE via the network.

The network as defined herein includes an access network, a metro area network, and a wide area network. The service provisioning engine employs at least the access network in provisioning the service, the access network including a hybrid fiber-coax network which may also be employed for providing non-provisioned, or legacy, signals to a user.

In this manner, executable scripts, such as XML conformant files, are generated by the executable element generator, and recognized by the service provisioning engine via the script processors. Further, since the executable scripts are XML conformant, they are capable of being recognized and applied on behalf of each of the provisioning objects with which the service provisioning engine communicates. The use of the executable element generator allows the executable scripts to be regenerated on demand to correspond to changes in the provisioning objects, services, or service plans, without redesigning or manually recoding adaptor routines to correspond to the new provisioning objects, services, or service plans. In alternate embodiments, other forms of executable script files may be employed to accommodate various deployment and compatibility issues. The system therefore provides a rapidly customizable and configurable service provisioning implementation.

In a particular embodiment, the service provisioning engine comprises a workflow manager and the executable scripts comprise workflow configuration files, workflow definition files, and task definition files. The workflow manager is configurable by loading a workflow configuration file defining network provisioning objects. The workflow definition files define a workflow comprising: a workflow name, a workflow state, a workflow mode, a workflow task name, workflow task arguments and a workflow task failure process, each workflow being associated with a network provisioning object. The task definition files define workflow tasks executed by a workflow engine as part of the workflow, and include a workflow task name, a workflow task description, a workflow task object class and workflow task arguments, such that the workflow manager fulfills a network service provisioning request by selecting an appropriate workflow and causing the associated workflow tasks to be executed by the workflow engine to provide automated network service provisioning.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of the present invention;

FIG. 2 shows the local broadband access networks of FIG. 1;

FIG. 3 shows a block diagram of a service provisioning system;

FIG. 4 shows the service provisioning system of FIG. 3 in greater detail;

FIGS. 5a-5d show flowcharts of service provisioning as defined by the present invention; and

FIG. 6 shows a particular embodiment including a workflow manager.

### DETAILED DESCRIPTION OF THE INVENTION

A description of preferred embodiments of the invention follows.

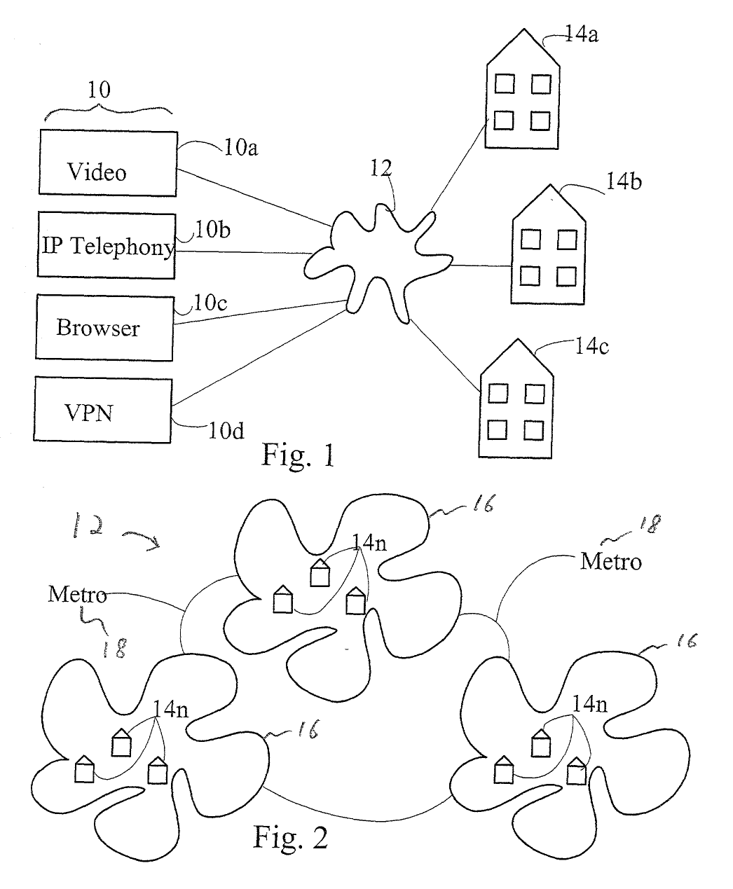

A hybrid fiber-coax network is employed for provisioning services to users. Services are provided through a service provisioning system via a network as described below. FIG. 1 shows a context diagram of the present invention. Referring to FIG. 1, a plurality of services 10 are available for provisioning to users 14a-14c via a network 12. The users 14a-14c are shown as exemplary. A plurality 14a-14n of users can be supported. The network 12 may include a public access network such as the Internet and other networks described further below. The services include video 10a, such as pay-per-view, video on demand, and digital cable; IP telephony 10b, such as voice-over-IP (VIOP) and digital telephones; Internet access via a web browser 10c, and Virtual Private Networks (VPN) 10d. Other services can be similarly provisioned.

FIG. 2 shows the network 12 in more detail. Referring to FIG. 2, the network 12 includes a plurality of local broadband access networks (LBANs) 16, interconnected across a metro area network 18. Each of the LBANs 16 includes at least a portion of a hybrid fiber-coax (HFC) network connected to individual users 14n generally. The metro area network is typically a public access network such as the Internet, and may be connected to other metro area networks via a wide area network (WAN, not shown). As indicated above, the use of an LBAN 16 allows services to be provisioned (provided) directly to the end users 14n using existing coax cables comprising the coax part of the HFC network. The metro area network 18 provides a high bandwidth connection from the network 12 to the LBAN 16 via an optical or other node serving each LBAN 16. In a typical embodiment, services are provisioned from a service delivery center (not shown), operated by the service provider, via the LBAN 16 in conjunction with the network 12.

In a particular embodiment, the LBAN is a Narad Broadband Access Network (NBAN) provided by Narad Networks Inc., of Westford, Mass., assignee of the present application, and as described in copending U.S. patent application Ser. No. 09/952,482, filed Sep. 13, 2001, entitled “Network Architecture for Intelligent Network Elements,” (Attorney Docket No. 3070.1000-003), incorporated herein by reference. As disclosed above, each LBAN serves approximately 500-1000 homes from a high speed optical unit such as an optical network distribution switch, employing the LBAN for the “last mile” connection from the high-speed trunk provided by the optical unit to the user via the legacy coax network.

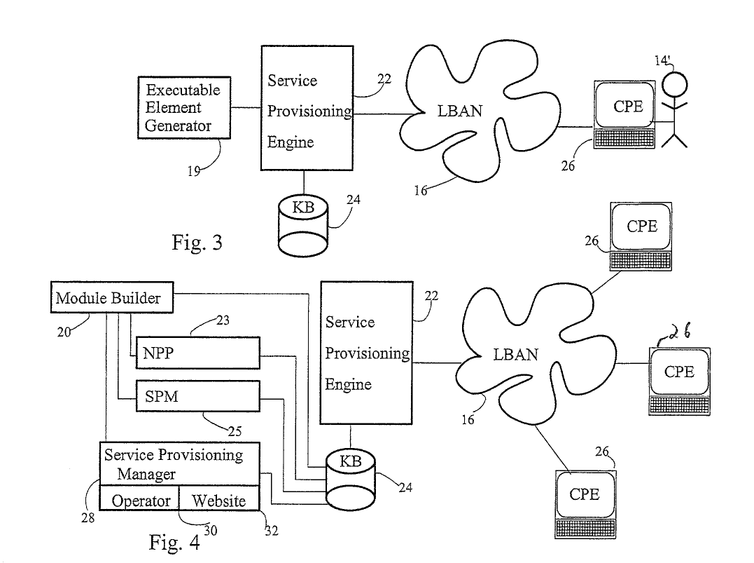

FIG. 3 shows a block diagram of the service provisioning system. Referring to FIG. 3, an executable element generator 19 is connected to a service provisioning engine 22. The executable element generator 19 generates executable scripts which are interpreted by the service provisioning engine 22. The executable element generator 19 is typically driven by a graphical user interface (GUI) invoked by a human operator. A knowledge base 24 stores the executable scripts and associated parameters. The service provisioning engine 22 is in communication with the LBAN 16, either directly or via other portions of the network 12 (FIG. 1), and provides the service via the LBAN 16. A user 14′ receives the service via one or more units of customer premises equipment (CPE) 26 also connected to the LBAN. CPEs 26 include PCs, telephones, TVs, and other devices adapted to be connected to the LBAN 16. The executable element generator 19 generates executable scripts directing the service provisioning engine 22 how to provide a particular service. In a particular embodiment, the executable scripts are XML conformant scripts structured as a workflow, described further below. As described above, XML is a generic, platform independent syntax which may be interpreted by multiple platforms. The executable scripts as defined herein are therefore applicable to a plurality of platforms which recognize the XML language. In alternate embodiments, other script or language formats may be employed. The service provisioning engine 22 reads the executable scripts and may read associated executable scripts and parameters from the knowledge base 24. The service is then provisioned, or provided to the user, via the LBAN 16, typically by sending messages to the CPE 26 and other provisioning objects concerned with providing the service. In a particular embodiment, the services are provisioned on a network as defined in copending U.S. patent application entitled “System and Method for Network Service Provisioning,” filed concurrently, Attorney Docket No. 3070.1003-001, incorporated herein by reference in its entirety.

FIG. 4 shows the service provisioning system of FIG. 3 in more detail. Before describing FIG. 4, some background on service provisioning may prove beneficial. Services are provided in the form of network transmissions and interactions which are selectively enabled for users who have subscribed to the service. The services as employed in the present system are an enumerated collection of network-based operations and/or transmissions initiated by a service provider, typically on a revenue-generating fee-for-services basis. An example is video-on demand transmitted from the service provider to the user's CPE 26. A service is typically, but not necessarily, associated with one or more provisioning objects for providing the service. A provisioning object may be, for example, a router operable to provide QOS based throughput sufficient for video-on-demand. Each provisioning object associated with a service has configuration parameters which are used to configure the provisioning object for providing the service according to the requirements of the service provider. Configuration parameters are directed to a particular hardware provisioning object for provisioning a particular service, such as assigning ports and buffers within a device.

Similarly, each service also has element parameters which direct the provisioning object in providing the service. The element parameters direct the provisioning object how to provide at least a portion of the service. For example, service parameters for a video-on-demand service may direct a router to deliver at a QOS level of guaranteed variable bit rate real-time.

Additionally, each service has one or more service plans. A service plan is an instantiation of a service offered by a particular service provider. For example, a video-on-demand service provider may have one service plan providing ten movies a month and another service plan providing twenty movies a month.

Referring to FIG. 4, the executable element generator includes a module builder 20 for initially generating the executable scripts. The script processors which consume the executable scripts and generate provisioning parameters include a network pre-provisioning (NPP) generator 23, a service plan manager (SPM) 25, and a service provisioning manager 28 (SM). The module builder 20 is a graphical user interface which generates executable scripts indicative of provisioning parameters for a particular provisioning object, such as network elements, services, and service plans. This tool allows a vendor to describe a provisioning object as it relates to the system in the syntax employed by the executable scripts. The module builder 20 can be employed, for example, by a vendor manufacturing hardware to be interconnected over the LBAN, such as a router manufacturer for routing video-on-demand or a laptop manufacturer on which the video-on-demand is to be received. The executable script is then stored in the knowledge base 24 along with an indicator so that it may be employed by the script processors to provide the service 10, (FIG. 1).

The NPP 23 generator allows a service provider to process executable scripts including defining configuration parameters corresponding to a particular network element. The configuration parameters allow the service provider to configure the network element provisioning object for a service, and would be invoked by the service provider, such as a network operator, to whom the network element was supplied. The NPP 23 receives an executable script generated by the module builder 20 for each network element concerned with providing the service. The NPP 23 then allows a network engineer at the service provider to configure the network element by defining the element parameters.

The SPM 25 allows a service provider to process executable scripts including element parameters corresponding to a particular service 10 (FIG. 1). The element parameters allow the service provider to direct the provisioning object how to perform the service, and would be invoked by the service provider to which the provisioning object was supplied. The SPM 25 receives an executable script generated by the module builder 20 for each provisioning object concerned with providing the service. The SPM 25 then allows a network engineer at the service provider to describe their service as it relates to a provisioning object in the syntax of the executable script. In the example above, the SPM 25 would be employed by the video-on-demand service provider to generate a script to direct the router and the laptop accordingly, for example to transmit and receive at a particular number of bits per second or frames per second. Other exemplary element parameters include maximum frame error rate, retry timeout and rate, port number (application type), and TCP/IP error recovery variables such as the slow start window and fast retransmit.

A service provisioning manager (SM) 28 allows generation of an executable script defining a particular instantiation of a service (10, FIG. 2), or service plan, to be defined. Service parameters are defined within each of the service plans via the GUI of the SPM 28. The SPM defines an instantiation of the service in terms of service parameters, including variables specific to a particular user, such as price, duration, billing options, and others. In the above example, a particular service plan might specify that the video-on-demand service provides a movie for a 24 hour period, or, for example, a service plan applicable to subscribers in Westford, Mass. which encompasses knowledge of the local cable provider's coax network. The SPM 25, therefore, allows an operator to process executable scripts for specifying service parameters corresponding to each service plan.

The three types of script processors NPP 23, SPM 25, and SPM 28 each receive, or consume the executable scripts from the module builder (executable element generator). Each script processor processes the scripts to define provisioning parameters for a provisioning object. Each script processor is operable to receive service provisioning input from a particular type of client, and defines a particular type of provisioning parameters such that the service provisioning engine 22 may receive the provisioning parameters and direct the corresponding provisioning object accordingly. Specifically, the NPP 23 defines configuration parameters applicable to network elements, and would typically be invoked by a network operator (NOP) responsible for maintaining the network elements in running order. The SPM 25 defines element parameters applicable to services, and would be invoked by a service provider to set up a service. The SPM 28 defines service parameters applicable to a service plan, and would be invoked by a telephone operator or web interface responsive to an end user request for a specific service to be provisioned, described further below.

Each of the provisioning parameters from the executable scripts is written to the knowledge base 24 for later retrieval by the service provisioning engine 22. An indicator corresponding to the service and the service provider is also written so that the executable scripts may be indexed and retrieved. In a particular embodiment, the knowledge base is an LDAP directory.

The service provisioning manager 28 initiates provisioning of a service in response to a request from a user 14. By employing the executable script or scripts corresponding to a service 10 (FIG. 1), a user may select from among available service plans and relevant service parameters associated with the plan. The service provisioning manager 28 employs both an operator interface 30 and a web-based interface 32. The operator interface 30 is staffed by a human operator who initiates the service in response to a telephone call, email, hardcopy mail, or other indirect request, and is ideal for a user unfamiliar with GUIs. Such an interface may be employed at a service delivery center comprising the service provider's servers and equipment. The web-based interface 32 may be accessed directly by a user who enters information specifying the service plan and service parameters desired, along with other pertinent personal and billing information.

The service provisioning manager 28 then directs the service provisioning engine 22 to provide the service to the CPE 26 of the user via the LBAN 16. The service provisioning engine 22 retrieves the applicable provisioning parameters resulting from the processing of the executable scripts, including the service parameters, the element parameters, and the configuration parameters from the knowledge base 24. In this manner, a general purpose service provisioning system is established which can provision a plurality of services for a plurality of users across multiple platforms supporting XML conformant files by employing the executable element generator to generate executable scripts concerned with provisioning the services.

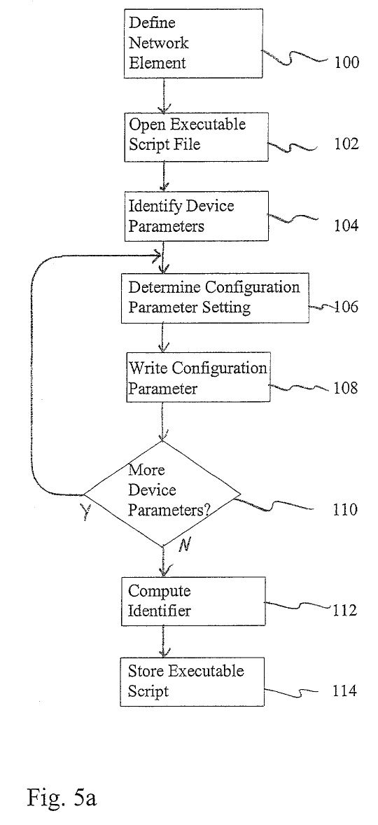

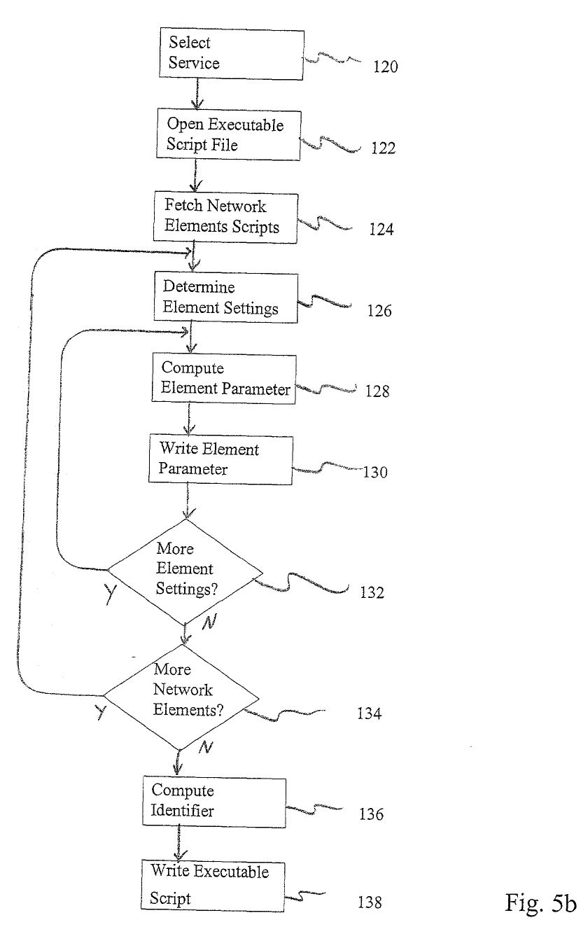

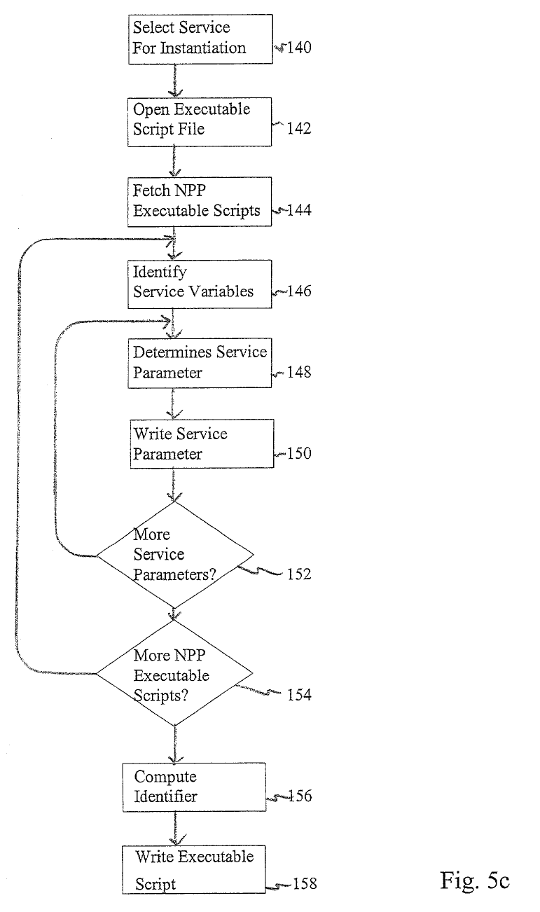

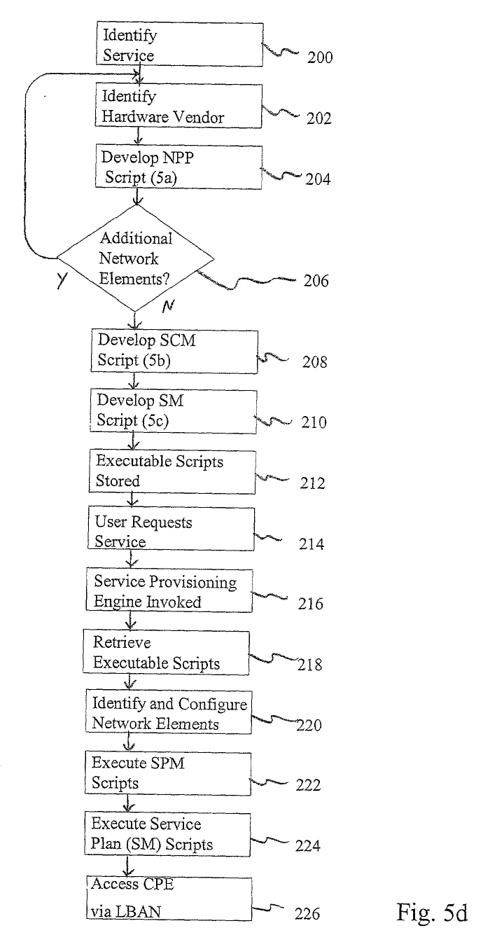

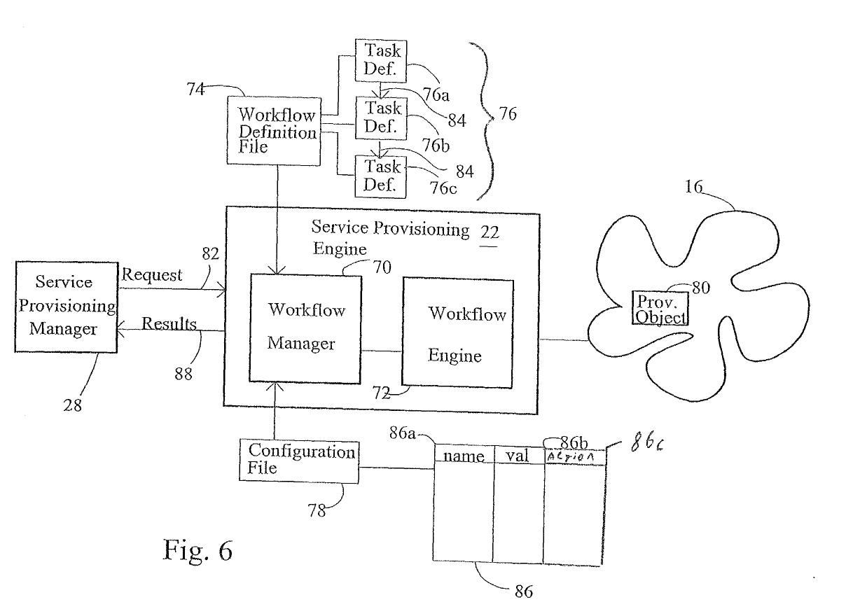

FIGS. 5a-5d show flowcharts of the service provisioning system. Referring to FIG. 5a, a flowchart of the operation of the network pre-provisioning (NPP) manager 23 (FIG. 4) is shown. A network element provisioning object (80, FIG. 6) is defined which is to be employed in providing one or more services, as depicted at step 100. An executable script file corresponding to the provisioning object 80 is opened, as described at step 102. The network element device parameters or settings concerned with providing one or more services are identified, as shown at step 104. For each device parameter, the operator determines a configuration parameter (provisioning parameter) setting or value for the device parameter, as depicted at step 106. An entry having the configuration parameter indicative of the determined parameter setting is written to the executable script, as disclosed at step 108. A check is performed to determine if there are more device parameters for this provisioning object, as shown at step 110. If there are more device parameters, control reverts to step 106. If there are no more device parameters for this provisioning object, an identifier for the processed executable script is computed, as disclosed at step 112. The processed executable script is then stored in the knowledge base 24 (FIG. 4) along with the identifier, as depicted at step 114.

FIG. 5b shows a flowchart of the service plan manager (SPM) generator 25 (FIG. 4). Referring to FIG. 5b, a service is selected for pre-provisioning, as disclosed at step 120. An executable script file corresponding to the service is opened, as described at step 122. The executable script processed by the network pre-provisioning manager (NPP) 23 for any provisioning objects concerned with provisioning the service may also be fetched from the knowledge base (FIG. 4), as shown at step 124. For each provisioning object concerned with provisioning the service, element settings for the provisioning object are determined from the executable script, as depicted at step 126. For each element setting, the operator determines the element parameter (provisioning parameter) for the element setting, as depicted at step 128. An entry having the element parameter corresponding to the element setting is written to the executable script, as disclosed at step 130. A check is performed to determine if there are any more element settings for the current provisioning object, as shown at step 132. If there are, control reverts to step 128. If there are no more element settings for the current provisioning object, a check is performed to see if there are any more provisioning objects concerned with provisioning this service, as depicted at step 134. If there are, control reverts to step 126, otherwise an identifier for the service and the corresponding processed executable script are computed, as disclosed at step 136. The processed executable script and the corresponding identifier are then written to the knowledge base, as shown at step 138.

FIG. 5c shows a flowchart of the executable scripts created for processing by the service provisioning manager (SM) 28. Referring to FIG. 5c, a service is selected for instantiation, as shown at step 140. An executable script file corresponding to this instantiation, or service plan, is opened, as depicted at step 142. Executable scripts created on behalf of the NPP generator 23 for this service may be fetched from the knowledge base, as shown at step 144. For each NPP processed executable script associated with this service, service variables are identified, as shown at step 146. An operator determines the proper service parameter for this service variable depending on the service plan desired, as shown at step 148. An entry having the service parameter (provisioning parameter) is written to the executable script, as depicted at step 150. Other service parameters not specific to the NPP executable script may be entered as well. A check is performed to determine if there are more service parameters corresponding to this NPP processed executable script, as disclosed at step 152. If there are, control reverts to step 148, otherwise a check is performed to determine if there are any more NPP executable scripts for this service plan, as shown at step 154. If there are more NPP executable scripts, then control reverts to step 146, otherwise, an identifier for this service plan is computed, as shown at step 156. The processed executable script including associated provisioning parameters and the identifier are then written to the knowledge base, as depicted at step 158.

FIG. 5d shows a flowchart of the service provisioning flow comprising the flows shown in FIGS. 5a-5c. Referring to FIG. 5d and FIG. 4, a service provider identifies a service 10 (FIG. 1) for provisioning via the LBAN 16, as depicted at step 200. A hardware vendor is identified to develop or provide a provisioning object for providing the service, as shown at step 202. An executable script corresponding to the provisioning object is processed by the vendor employing the NPP 23, including the sequence shown in FIG. 5a, as disclosed at step 204. A check is performed to determine if there are additional provisioning objects concerned with providing the service, as shown at step 206. If there are additional provisioning objects, control reverts to step 202. Otherwise an NPP 23 script corresponding to the service is developed, including the sequence shown in FIG. 5b, as disclosed at step 208. The service plan manager 25 is then invoked to develop an executable script corresponding to service plans corresponding to the service, as described in FIG. 5c and depicted at step 210. Processed executable scripts for providing an instantiation of the service are now stored in the knowledge base from each of steps 204, 208 and 210, as shown at step 212. A user requests an instantiation of the service by accessing the service provisioning manager 28, as disclosed at step 214. As indicated above, the service provisioning manager 28 may be accessed directly via the web or indirectly via a human operator at the service operations center. The service provisioning manager 28 receives the user request, and invokes the service provisioning engine 22 to provision the service, as depicted at step 216. The service provisioning engine 22 then retrieves the processed executable scripts corresponding to the service from the knowledge base, as shown at step 218. The provisioning objects concerned with provisioning the service are then identified and configured by the service provisioning engine 22 by executing, by the service provisioning engine 22, the executable scripts processed by the NPP 23, as described at step 220. If required, executable scripts concerning the service and processed by the SPM 25 are executed by the service provisioning manager 28, as shown at step 222, to initialize the provisioning objects. The executable scripts processed by the SPM 28 comprising the service plan are then executed by the service provisioning engine to provision the service, as described at step 224. The LBAN is accessed to determine the CPE of the target user of the provisioned service, as disclosed at step 226, and the service provisioned by accessing the CPE at the user site. In this manner, services are scalably and dynamically provisioned for each user over the LBAN by employing the executable scripts concerned with providing the service.

In a particular embodiment, shown in FIG. 6, a workflow manager is employed. Referring to FIG. 6, the service provisioning engine 22 includes a workflow manager 70 and a workflow engine 72. The executable scripts further include workflow definition files 74, task definition files 76, and workflow configuration files 78. The workflow manager 70 reads the executable scripts, and directs the workflow engine 72 to execute the executable scripts to complete a provisioning request 82 for a particular provisioning object 80 on the LBAN 16.

The workflow manager 70 reads a workflow configuration file 78, which may be stored separately or may be stored in the KB 24 (FIG. 4). The workflow configuration file contains a hash table 86 indicative of a mapping of a provisioning object 80, an action operable to be performed on the object (task), and the corresponding workflow. A name 86a corresponds to a particular provisioning object 80 for which a provisioning request 82 was received for. A value 86b is indicative of a particular workflow to be performed or applied. An action 86c indicates the particular action or task to be applied. Each workflow definition file 74 corresponds to a particular workflow. A workflow definition file 74 encompasses one or more tasks 76a-76n. A workflow typically executes several tasks 76 in the course of completing a provisioning request 82 for a particular provisioning object 80. The tasks are stored in task definition files which may each include one or more tasks.

The workflow manager 70 receives a provisioning request 82 from a user interface (UI) client such as the service provisioning manager 28. The workflow engine executes the corresponding workflow to apply the workflow tasks 76 to the provisioning object 80. The workflow engine 72 executes the workflow definition file 74 and the corresponding task definition files 74 for the particular provisioning request 82. The task definition files 76 are invoked in a particular order according to the workflow, such that the output of one task 76a, for example, can be an input to a subsequent task 76b, as shown by arrows 84. The corresponding operations are applied to the affected provisioning object 80, and the provisioning results 88 returned to the service provisioning manager 28.

The workflow definition file 74 defines a state machine that contains the various states relevant to completion of the provisioning request 82. Various task definition files 76 are executed in a particular state, according to state transition rules encapsulated in the workflow definition file 74. Further, task definition files 76 may be executed in a serial or parallel mode depending on the state. Fault detection and correction states may be defined to ascertain success or failure of a provisioning request 82 or portion thereof. A reload operation may be employed to refresh the workflow from the workflow configuration file to allow for new provisioning objects to be deployed. In this manner, the workflow manager allows dynamic integration of additional provisioning objects using a modular approach to facilitate such items as billing and fault management.

In this particular embodiment, the workflow definition files 74, task definition files 76, and workflow configuration files may be implemented as XML files. The workflow manger may be implemented as a session bean in an enterprise Javabeans (EJB) container. Alternatively, other embodiments may employ alternate implementations without departing from the workflow task sequence.

Those skilled in the art should readily appreciate that the programs for service provisioning and workflow definition as defined herein are deliverable to a computer in many forms, including but not limited to a) information permanently stored on non-writeable storage media such as ROM devices, b) information alterably stored on writeable storage media such as floppy disks, magnetic tapes, CDs, RAM devices, and other magnetic and optical media, or c) information conveyed to a computer through communication media, for example using baseband signaling or broadband signaling techniques, as in an electronic network such as the Internet or telephone modem lines. The operations and methods may be implemented in a software entity executable by a processor or as a set of instructions embedded in a carrier wave. Alternatively, the operations and methods may be embodied in whole or in part using hardware components, such as Application Specific Integrated Circuits (ASICs), state machines, controllers or other hardware components or devices, or a combination of hardware, software, and firmware components.

While this invention has been particularly shown and described with references to preferred embodiments thereof, it will be understood by those skilled in the art that various changes in form and details may be made therein without departing from the scope of the invention encompassed by the appended claims. Accordingly, the present invention is not intended to be limited except by the following claims.

What is claimed is:

1. A system for providing services over a network comprising:
at least one executable element generator, the executable element generator operable to generate executable scripts;
a plurality of services, each of the services corresponding to at least one of the executable scripts;
a network in communication with a plurality of users; and
a service provisioning engine (SPE) operable to execute the executable scripts for provisioning the corresponding service via the network.

2. The system of claim 1 further comprising script processors, the script processors operable to process the executable scripts and the service provisioning engine responsive to the script processors for executing the executable scripts.

3. The system of claim 2 wherein the script processors further include a network pre-provisioning (NPP) manager, a service plan manager (SPM), and a service provisioning manager (SM).

4. The system of claim 2 further comprising provisioning parameters, the provisioning parameters defined by the script processors in response to the executable scripts.

5. The system of claim 4 wherein the provisioning parameters further comprise configuration parameters, element parameters, and service parameters.

6. The system of claim 4 further comprising provisioning objects, each of the provisioning objects responsive to provisioning parameters corresponding to the particular provisioning object.

7. The system of claim 1 wherein the executable element generator further comprises a module builder, the module builder operable to generate executable scripts indicative of provisioning parameters for at least one of the provisioning objects.

8. The system of claim 1 wherein the executable script further comprises configuration parameters applicable to network elements, wherein the network elements are responsive to the executable script.

9. The system of claim 8 further comprising a network pre-provisioning generator (NPP), the NPP further operable to define configuration parameters corresponding to each of the network elements.

10. The system of claim 9 wherein the executable script includes the configuration parameters and the network elements are responsive to the configuration parameters for providing at least a portion of the service.

11. The system of claim 1 further comprising a service configuration manager (SPM), the SPM further operable to define element parameters corresponding to each of the services.

12. The system of claim 11 wherein the executable script includes the element parameters and further comprising provisioning objects responsive to the element parameters for providing at least a portion of the service.

13. The system of claim 1 further comprising service plans, each of the service plans including service parameters corresponding to a particular corresponding service.

14. The system of claim 13 wherein the executable script includes the service parameters and the service provisioning engine is responsive to the service parameters for providing the service.

15. The system of claim 13 wherein the executable element generator further comprises a service provisioning manager (SM) operable to define the service parameters.

16. The system of claim 1 wherein the executable element generator is a graphical user interface (GUI).

17. The system of claim 1 further comprising a knowledge base, the knowledge base operable to store the executable scripts and related parameters, the related parameters including at least one of configuration parameters, element parameters, and service parameters.

18. The system of claim 17 wherein the knowledge base is farther operable to store an indicator corresponding to a provisioning object associated with the corresponding configuration parameters.

19. The system of claim 17 wherein the knowledge base is further operable to store an indicator corresponding to each of the services associated with the corresponding element parameters.

20. The system of claim 17 wherein a knowledge base is further operable to store an indicator corresponding to each of the service plans associated with the corresponding service parameters.

21. The system of claim 17 wherein the knowledge base further comprises an LDAP directory.

22. The system of claim 17 wherein the service provisioning engine is in communication with the knowledge base for providing the service.

23. The system of claim 1 further comprising an access network in communication with the service provisioning engine for providing the service.

24. The system of claim 23 further comprising customer premises equipment (CPE) in communication with the service provisioning engine via the access network, the customer premises equipment for providing the services to an end user.

25. The system of claim 24 wherein the access network further comprises a hybrid fiber-coax (HFC) network.

26. The system of claim 25 wherein the access network further comprises a local broadband access network (LBAN).

27. The system of claim 23 further comprising an execution environment, the execution environment including at least one of a metro area network, wide area network, and access the network.

28. The system of claim 27 wherein the execution environment further comprises a public access network.

29. The system of claim 28 wherein the public access network is the Internet.

30. The system of claim 27 wherein the services are provided via the execution environment.

31. The system of claim 30 wherein the execution environment is operable on a plurality of platforms.

32. A method for provisioning a service over a network comprising:
providing a network, the network interconnecting a plurality of users;
enumerating at least one service adapted to be provided via the network, the network operable to provide the services to each of the plurality of users;
generating at least one executable script corresponding to the service via an executable element generator; and
executing, via a service provisioning engine, the at least one executable script to provision the service via the network.

33. The method of claim 32 wherein executing further comprises processing, via a script processor, the executable script, the service provisioning engine responsive to the script processor for executing the executable script.

34. The method of claim 32 further comprising providing a plurality of provisioning objects, the provisioning objects operable to be interconnected via the network, each of the provisioning objects having configuration parameters corresponding to the particular provisioning object.

35. The method of claim 34 wherein generating the executable script further comprises generating the configuration parameters applicable to the provisioning objects, the provisioning objects being responsive to the executable script.

36. The method of claim 35 further comprising a network pre-provisioning generator (NPP) responsive to the executable element generator wherein processing the executable script further comprises defining a set of configuration parameters for each of the provisioning objects via the network pre-provisioning generator (NPP).

37. The method of claim 32 further comprising a service plan manager (SPM) responsive to the executable element generator wherein processing the executable script further comprises generating element parameters corresponding to each of the services via the service plan manager (SPM).

38. The method of claim 37 wherein the executable script includes the element parameters, the provisioning objects responsive to the element parameters for providing at least a portion of the service.

39. The method of claim 32 further comprising providing service plans, wherein generating the executable script further comprises generating service parameters corresponding to a particular service.

40. The method of claim 39 wherein the executable script includes the service parameters and the execution engine is responsive to the service parameters for providing the service.

41. The method of claim 40 wherein generating the service parameters further comprises invoking a service provisioning manager operable to define the service parameters.

42. The method of claim 32 wherein generating the executable script further comprises invoking an executable element generator via a graphical user interface (GUI).

43. The method of claim 32 wherein generating the executable script further comprises referencing a knowledge base, the knowledge base operable to store executable scripts and related provisioning parameters concerned with providing the service.

44. The method of claim 43 wherein the knowledge base is further operable to store an indicator corresponding to each of the executable scripts.

45. The method of claim 43 wherein referencing the knowledge base further comprises accessing an LDAP directory.

46. The method of claim 43 wherein executing the executable script further comprises referencing the knowledge base for providing the service.

47. The method of claim 32 wherein executing the executable script further comprises transmitting via an access network in communication with the service provisioning engine for providing the service.

48. The method of claim 47 wherein executing the executable script further comprises accessing customer premises equipment in communication with the service provisioning engine via the access network, the customer premises equipment for providing the services to an end user.

49. The method of claim 47 wherein providing a network further comprises providing an execution environment, the execution environment including at least one of a metro area network, wide area network, and the access network.

50. The method of claim 49 wherein the execution environment further comprises a public access network.

51. The method of claim 50 wherein the public access network is the Internet.

52. The method of claim 49 wherein provisioning the service further comprises provisioning via the execution environment.

53. The method of claim 52 wherein the execution environment is operable on a plurality of platforms.

54. A system for providing dynamically re-configurable, file driven, workflow support for automated network service provisioning, comprising:
a workflow manager configurable by loading a workflow configuration file defining network provisioning objects;
a workflow definition file defining a workflow, each workflow being associated with a network provisioning object, the workflow manager responsive to the workflow definition file;
at least one task definition file defining workflow tasks executed as part of the workflow defined in the workflow definition file, the workflow manager operable to fulfill a network service provisioning request by selecting a particular workflow and operable to invoke the associated workflow tasks to be executed by a workflow engine to provide automated network service provisioning.

55. The system of claim 54 wherein the workflow configuration file is re-loaded, while the workflow manager is executing, to re-configure the workflows available for network service provisioning.

56. The system of claim 54 wherein the workflow definition file is operable to be reloaded, while the workflow manager is executing, to re-configure the workflow tasks associated with the workflow.

57. The system of claim 54 wherein the task definition file is operable to be reloaded, while the workflow manager is executing, to re-configure the workflow task object class associated with the workflow task.

58. The system of claim 54 wherein the workflow configuration file, the workflow definition file and the task definition file are formatted using XML.

59. The system of claim 54 wherein the workflow task arguments are configured such that an output argument of a first workflow task is the input argument to a second workflow task.

60. The system of claim 54 wherein the workflow tasks further comprise a workflow state, the workflow state including a workflow state name and a workflow state mode.

61. The system of claim 60 wherein the workflow state mode directs the workflow tasks to execute serially or in parallel.

62. The system of claim 54 wherein the workflow tasks are implemented on a heterogeneous platform.

63. The system of claim 62 wherein the workflow tasks further comprise Java objects.

64. The system of claim 62 wherein the workflow tasks are implemented as Enterprise Java Beans.

65. The system of claim 64 wherein the Enterprise Java Beans contain state information.

66. The system of claim 64 wherein the Enterprise Java Beans are stateless.

67. The system of claim 60 wherein the workflow tasks are organized by the workflow state.

68. The system of claim 54 wherein the workflow manager provides an interface for integration of external systems.

69. The system of claim 65 wherein the external systems include at least one of a billing system, a fault management system and an element management system.

70. The system of claim 54 wherein automated network service provisioning dynamically realizes and executes a newly formed service as part of a service creation process.

71. The system of claim 54 wherein various states of the workflow tasks are monitored from a user interface using the Java Messaging System.

72. The system of claim 54 wherein detection of a failure within the workflow causes an automatic rollback that includes rolling back predefined operations of the workflow tasks executed as part of the workflow.

73. The system of claim 69 wherein the automatic rollback includes an operation comprising at least one of: rollback all previous tasks, jump to another state and resume execution of tasks, or abort and return status.

74. The system of claim 54 wherein the workflow further comprises a workflow name, a workflow state, a workflow mode, a workflow task name, workflow task arguments and a workflow task failure process.

75. The system of claim 54 wherein the task definition file further comprises the workflow task name, a workflow task description, a workflow task object class and the workflow task arguments.

76. A method for provisioning services over a network via a services delivery platform comprising:
providing an execution environment operable to deploy services to a plurality of users on the network, the execution environment operable on a plurality of platforms;
defining a plurality of provisioning objects, each of the provisioning objects adapted to be interconnected over the network;
determining a set of configuration parameters corresponding to each of the provisioning objects, the configuration parameters operable to manipulate the provisioning object;
defining a plurality of services available over the network, each of the plurality of services corresponding to at least one of the provisioning objects;
determining a set of element parameters corresponding to each of the services, the element parameters operable to direct the provisioning objects to perform at least a portion of the service;
defining a service plan corresponding to at least one of the services, the service plan corresponding to a particular instantiation of the service;
determining a set of service parameters for each of the service plans, the service parameters corresponding to the service plan for implementing the particular instantiation of the service;
storing an indicator corresponding to each of the provisioning objects, services, and service plans in a common repository;
storing the configuration parameters, the element parameters, and the service parameters associated with the respective provisioning objects, services, and service parameters in the common repository;
providing a service provisioning engine operable to read and interpret the common repository; and
executing the service via the service provisioning engine in the execution environment.

77. The method of claim 76 wherein the common repository is a knowledge base and generating the executable script further comprises referencing the knowledge base, the knowledge base operable to store at least one of the configuration parameters, the element parameters, and the service parameters.

78. The method of claim 77 wherein executing the service further comprises reading the configuration parameters, element parameters, and service parameters from the knowledge base.

79. The method of claim 76 wherein the knowledge base is an LDAP directory and the indicator corresponds to an entry in an LDAP directory.

80. The method of claim 76 wherein the users further comprise a customer and at least one piece of customer premises equipment (CPE).

81. A computer program product having computer program code for provisioning a service over a network comprising:
computer program code for providing interconnections over a network, the network interconnecting a plurality of users;
computer program code for enumerating at least one service adapted to be provided via the network, the network operable to provide the services to each of the plurality of users;
computer program code for generating at least one executable script corresponding to the service via an executable element generator; and
computer program code for executing, via a service provisioning engine, the at least one executable script to provision the service via the network.

82. A computer data signal including program code for provisioning a service over a network comprising:
program code for providing a network, the network interconnecting a plurality of users;
program code for enumerating at least one service adapted to be provided via the network, the network operable to provide the services to each of the plurality of users;
program code for generating at least one executable script corresponding to the service via an executable element generator; and
program code for executing, via a service provisioning engine, the at least one executable script to provision the service via the network.

83. A system for providing services over a network comprising:
means for providing a network, the network interconnecting a plurality of users;
means for enumerating at least one service adapted to be provided via the network, the network operable to provide the services to each of the plurality of users;
means for generating at least one executable script corresponding to the service via an executable element generator; and
means for executing, via a service provisioning engine, the at least one executable script to provision the service via the network.
